(19) United States
(12) Patent Application Publication
(10) Pub. No.: US 2008/0266073 A1
(43) Pub. Date: Oct. 30, 2008

(54) Method for Monitoring Tire Inflating Operation

(75) Inventors: Thomas H. Tu, Troy, MI (US); James L. Duffy, Macomb, MI (US)

Correspondence Address: GENERAL MOTORS CORPORATION;LEGAL STAFF, MAIL CODE 482-C23-B21, P O BOX 300, DETROIT, MI, 48265-3000, US

(73) Assignee: GM GLOBAL TECHNOLOGY OPERATIONS, INC., DETROIT, MI (US)

(21) Appl. No.: 11/739,708

(22) Filed: Apr. 25, 2007

(51) Int. Cl. B60C 23/02

(52) U.S. Cl. 340/442; 73/146.2

(57) ABSTRACT

A method for monitoring the fill-up of a vehicle tire to the cold inflation pressure recommended for a cold tire condition. The method includes establishing a calibration temperature that corresponds to temperature of air in a cold tire condition, determining that air is being added to the tire, measuring the temperature of the air in the tire and adjusting the measured tire pressure to compensate for the difference between the measured temperature and the calibration temperature corresponding to a cold inflation temperature, comparing the adjusted pressure with the manufacturer's recommended pressure cold inflation pressure to determine that the recommended tire pressure has been obtained and generating a signal cognizable by the operator outside the vehicle so that the operator will cease filling the tire when the pressure is obtained.

### FIELD OF THE INVENTION

The present invention relates to a method for monitoring the inflating of a tire with air, and more particularly a method for informing the operator that the recommended cold inflation tire pressure has been obtained.

### BACKGROUND OF THE INVENTION

It is known and required by motor vehicle regulations that the vehicle manufacturer must install a tire information placard on the pillar of the vehicle body. The placard specifies the recommended cold inflation pressure for the vehicle tires. Cold inflation pressure is the pressure that is measured after the vehicle has been sitting for at least three hours or has been driven for less than a mile. Filling the tire to the cold inflation pressure assures that when the tire heats up during driving, the inflation pressure will not be less than the cold inflation pressure. Thus, the tire will not be in an under inflated condition.

Modern vehicles are equipped with tire pressure monitoring systems that will advise the driver that a tire has low pressure. Alternatively, a driver can use a pocket-type pressure gauge to check the tire pressure.

When the tire pressure monitoring system determines that a tire is under inflated, a signal lamp is lit on the instrument panel and the driver will drive, often for more than a mile, to a service station to add air to the tire. The service station tire pump may have a pressure gauge to indicate the tire pressure so that an operator, either the driver or a service station attendant, can monitor the tire inflating process and learn when to stop adding air. Or the pocket-type pressure gauge may be used to check the tire pressure so that operator will know when to stop adding air to the tire.

It would be desirable to provide an improved method for monitoring the inflation of the heated tire after driving to the service station and advising the operator that the recommended cold inflation pressure has been obtained so that operator can stop adding air to the tire without resorting to a pressure gauge.

### SUMMARY OF THE INVENTION

A method is provided for monitoring the fill-up of a hot vehicle tire to the cold inflation pressure recommended for a cold tire condition. The method includes establishing a calibration temperature that corresponds to temperature of air in a cold tire condition, determining that air is being added to the tire, measuring the temperature of the air in the tire and adjusting the measured tire pressure to compensate for the difference between the measured temperature and a temperature corresponding to a cold inflation temperature, comparing the adjusted pressure with the manufacturer's recommended pressure cold inflation pressure to determine that the recommended tire pressure has been obtained and generating a signal cognizable by the operator outside the vehicle so that the operator will cease filling the tire when the pressure is obtained.

Areas of applicability of the present invention will become apparent from the detailed description provided hereinafter. It should be understood that the detailed description and specific examples, while indicating exemplary embodiments of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a schematic of a vehicle tire pressure monitoring system according to the invention; and

FIG. 2 is a flow chart showing the method steps of the tire pressure monitoring system of this invention.

### DETAILED DESCRIPTION OF THE EXEMPLARY EMBODIMENTS

The following description of certain exemplary embodiments is merely exemplary in nature and is not intended to limit the invention, its application, or uses.

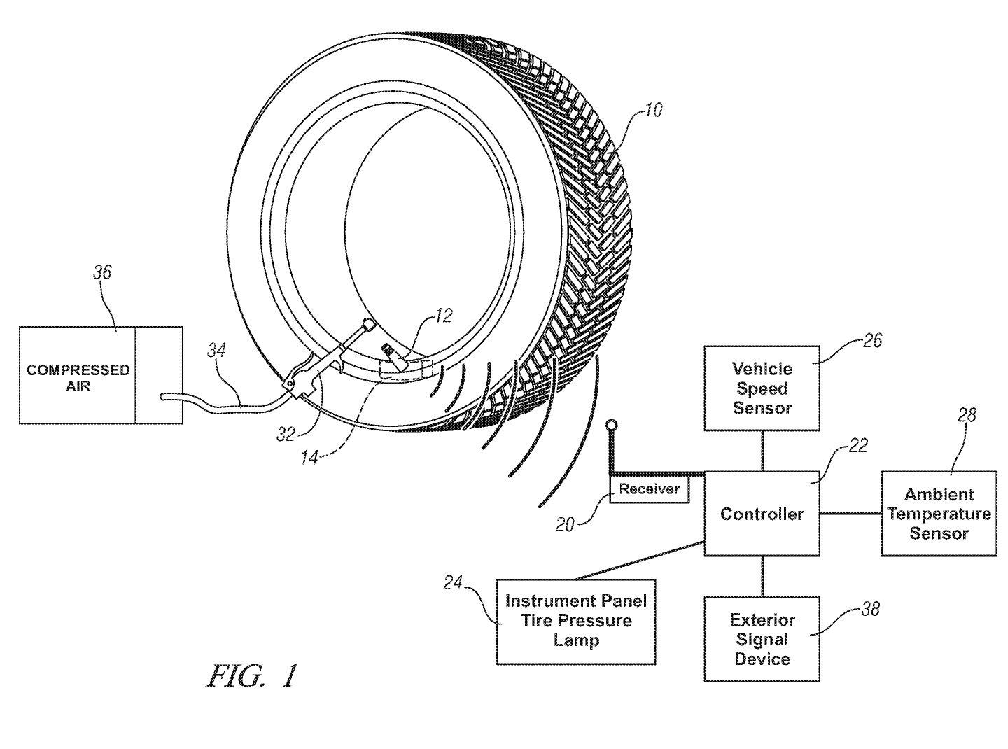

Referring to FIG. 1, a motor vehicle has a tire 10 equipped with a valve stem 12 for adding air to the tire 10. A conventional tire pressure sensor 14 is provided within the tire 10 and transmits a wireless signal containing data relating to the pressure and temperature of the air contained within the tire 10. The tire pressure sensor 14 is typically part of the valve stem 12 and is programmed to transmit a signal at a set interval, such as once a minute when the vehicle is moving or once an hour when the vehicle is stationary. In addition, the tire pressure sensor 12 will transmit a signal whenever the tire pressure changes by a predetermined amount.

The motor vehicle also has a receiver 20 that receives the wireless signal and a controller 22 that processes the pressure data and selectively energizes a warning lamp signal 24 to instruct the driver that the tire pressure is low and should be checked with a gauge. Thus, the driver will proceed to a service station where an operator will use a nozzle 32 and hose 34 connected to a compressed air source 36 to add air to the tire 10.

FIG. 1 also shows an exterior signal device 38 that will be energized according to the invention to advise a service station operator that the recommended cold inflation temperature has been reached and that no more air should be added to the tire 10. The exterior signal device 38 may be the vehicle horn or the vehicle lighting system or any other device for visually or audibly notifying an operator located outside the vehicle that the cold inflation pressure has been reached and no more air should be added to the tire 10.

A vehicle speed sensor 26 and an ambient temperature sensor 28 also provide inputs to the controller 22. The vehicle speed sensor 26 indicates that the vehicle is stationary. The vehicle speed sensor 26 may be a switch indicating that the vehicle transmission is in park, or a wheel speed sensor indicating that the wheels are not turning, or other sensor from which it may be deduced that the vehicle is not moving.

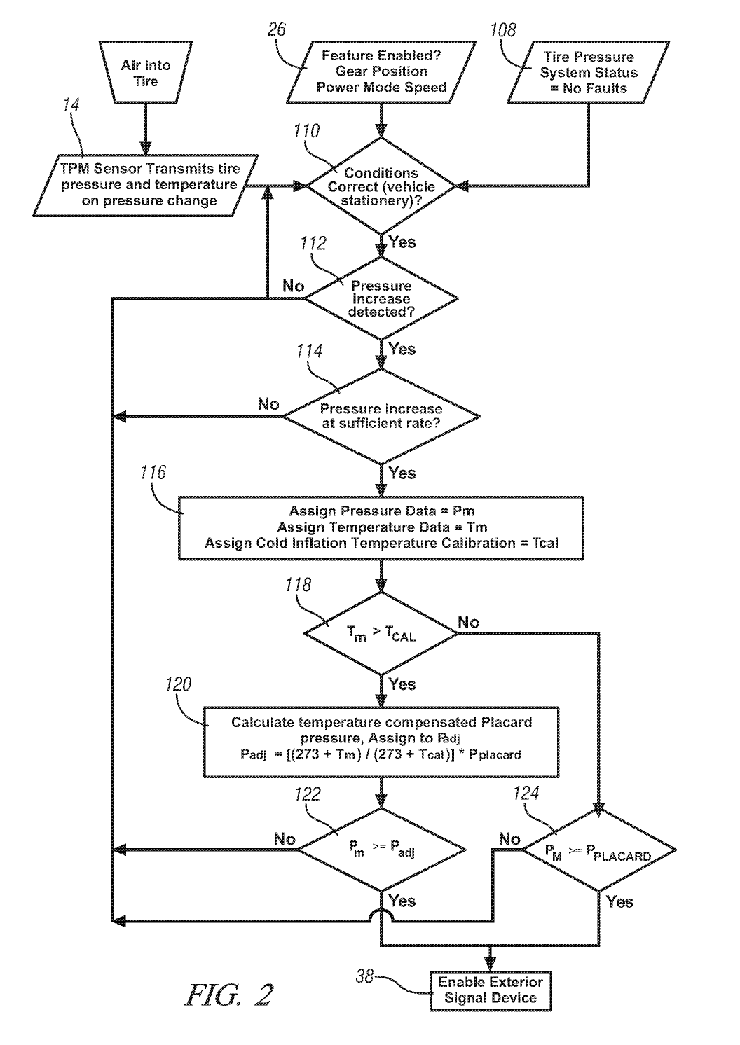

Referring to FIG. 2, a flow chart is shown for the method for monitoring the inflating of a tire with air, and more particularly a method for informing the operator that the desired cold inflation tire pressure has been obtained.

In FIG. 2, the tire pressure sensor 14 is transmitting tire pressure and temperature signals. The vehicle speed sensor 26 provides a signal by which it may be deduced that the vehicle is stationary and that it is accordingly possible that an operator could be adding air to the tire 10. The processor 22 collects and records data from the various sensors and performs a series of steps using the pressure and temperature inputs from the tire pressure sensor 14, and the inputs from the vehicle speed sensor 26 and ambient temperature sensor 28. The ambient temperature sensor 28 may be a conventional ambient temperature sensor that is commonly employed in vehicle engine control or HVAC systems.

In step 110, the condition of the vehicle speed sensor 26 is considered. If it is determined that the vehicle is not stationary, then the method does not progress as it can be deduced that the vehicle is moving and thus whatever pressure increase might be observed in the tire 10 cannot be the result of connecting the nozzle 32 to the valve stem 12. In addition, at step 110, the status of the tire pressure system is considered via a diagnostic system 108 that determines whether there is a fault in the system, for example, a failed pressure sensor, failed temperature sensor, low battery, etc. If a fault is detected, then the method does not progress.

If it is determined in step 110 that the vehicle is stationary and there are no faults in the system, then step 112 considers whether the pressure data transmitted from the tire 10 is indicative of an increasing pressure in the tire 10. For example, tire pressure data may be collected every 0.1 second to monitor the rate of pressure increase.

Step 114 determines that the rate of the pressure increase signifies that the tire is being inflated with an air compressor and rules out a slower rate of pressure increase that might be due to other factors such as an increased temperature imparted to the tire by the sun or by parking the vehicle on a hot roadway.

If step 114 determines that the tire 10 is being inflated with air, then at step 116 the air pressure measured in the tire 10 will be assigned to variable Pₘ and the air temperature measured in the tire will be assigned to variable Tₘ. In addition, a cold inflation calibration temperature is established and assigned to variable T_{cal}. T_{cal} represents the temperature corresponding to the cold inflation condition of the tire. T_{cal} is preferably the tire temperature Tₘ first measured in the tire upon vehicle power-up if the vehicle has been stationary for a predetermined time, for example three hours. If the vehicle has not been stationary for at least the predetermined time period at power-up, then T_{cal} will be the most recently saved Tₘ from an earlier power-up. Alternatively T_{cal} may be set using ambient temperature data from the ambient temperature sensor 28, or some other temperature that is determined by the system designer to represent a tire air temperature consistent with the tire air pressure not having been unduly influenced by heating of the air due to driving the vehicle.

In step 118, Tₘ is compared with a cold inflation calibration temperature, T_{cal}. If Tₘ, the temperature of the air in the tire 10, is greater than the cold inflation calibration temperature T_{cal}, then it can be concluded that the pressure Pₘ measured within the tire by the tire pressure sensor 14 is being influenced by a heated tire. For example, if the air in the tire 10 has been heated by driving, its temperature is greater than the cold inflation temperature and thus cannot be simply compared with the recommended placard pressure to determine if the cold inflation pressure has been obtained.

Thus, in step 120, the placard pressure P_{placard} is adjusted to an adjusted placard pressure P_{adj} to compensate for the influence of the higher temperature of the air in the tire 10. Thus, observing the gas laws, the formula employed in step 120 is:

P_{adj}=[(273+Tₘ)/(273+T_{cal})]*P_{placard}

In step 122, the measured pressure Pₘ is compared with the adjusted placard pressure P_{adj}. If the tire inflation process has progressed to the point where the measured pressure Pₘ is equal to or greater than the adjusted placard pressure P_{adj}, then it is concluded that the tire pressure has reached the cold inflation pressure and a signal is sent to energize the exterior signal device 38 so that the service station operator is notified that the placard pressure P_{placard} has been obtained and the tire filling operation can be terminated.

If at step 118 it is found that the measured tire temperature Tₘ is equal to or less than the T_{cal}, then it is concluded that the tire pressure is not being exaggerated by tire heating. Thus, at step 124 the measured pressure Pₘ can simply be compared with the cold inflation pressure P_{placard}. If the measured pressure Pₘ is equal to or greater than the cold inflation pressure P_{placard}, then a signal is sent to energize the exterior signal device 38 so that the service station operator is notified that the placard pressure P_{placard} has been obtained and the tire filing operation can be terminated.

The foregoing description of the invention is merely exemplary in nature and, thus, variations thereof are intended to be within the scope of the invention.

What is claimed is:

1. A method for monitoring the fill-up of a vehicle tire to the cold inflation pressure recommended for a cold tire condition, comprising:
establishing a calibration temperature that corresponds to temperature of air in a cold tire condition;
determining that air is being added to the tire;
measuring the temperature of the air in the tire and adjusting the measured tire pressure to compensate for the difference between the measured temperature and the calibration temperature corresponding to a cold inflation temperature;
comparing the adjusted pressure with the manufacturer's recommended pressure cold inflation pressure to determine that the recommended tire pressure has been obtained; and
generating a signal cognizable by the operator outside the vehicle.

2. The method of claim 1 further comprising determining that air is being added to the tire by detecting that the rate of pressure increase in a tire exceeds that which might occur from heating up of the tire.

3. The method of claim 1 further comprising determining that the vehicle is stationary and also observing that the rate of pressure increase in a tire exceeds that which might occur from heating up of the tire.

4. The method of claim 1 further comprising establishing the calibration temperature at the temperature of the air in the tire upon vehicle power-up after the most recent 3 hour period of the vehicle being stationary.

5. The method of claim 1 further comprising adjusting the measured pressure in the tire by the formula
P_{adj}=[(273+Tₘ)/(273+T_{cal})]*P_{placard}
where Tₘ is the air temperature measured in the tire, T_{cal} is the established calibration temperature and P_{placard} is the cold inflation temperature recommended for the vehicle.

6. The method of claim 1 further comprising generating a signal cognizable by the operator by flashing the vehicle exterior lights.

7. The method of claim 1 further comprising generating a signal cognizable by the operator by sounding the vehicle horn.

8. The method of claim 1 further comprising comparing the adjusted pressure with the manufacturer's recommended pressure cold inflation pressure by the steps of, if the temperature of air in the tire is equal to or less than the calibration temperature, then comparing the adjusted pressure with the manufacturer's recommended pressure cold inflation pressure to determine that the recommended cold inflation tire pressure has been obtained, or if the temperature of air in the tire exceeds the calibration temperature, then adjusting the measured tire pressure to compensate for the difference between the measured temperature and the calibration temperature corresponding to a cold inflation temperature and comparing the adjusted pressure with the manufacturer's recommended pressure cold inflation pressure to determine that the recommended cold inflation tire pressure has been obtained.

9. A method for monitoring the fill-up of a vehicle tire to the cold inflation pressure recommended for a cold tire condition, comprising:
collecting tire air pressure and tire air temperature data;
establishing a calibration temperature that corresponds to tire air temperature in a cold tire condition;
determining that the tire is being filled by air being added to the tire while the vehicle is stationary by observing the rate of pressure increase in the tire pressure data;
comparing the tire air temperature with the calibration temperature to determine whether tire air temperature is either at or below the cold inflation temperature and thus cold, or whether the tire air temperature is above the cold inflation temperature and thus hot;
if the tire air temperature is determined to be cold, then comparing the adjusted pressure with the manufacturer's recommended pressure cold inflation pressure to determine that the recommended tire pressure has been obtained, or if the tire air temperature is determined to be hot, then adjusting the measured tire pressure to compensate for the difference between the measured temperature and the calibration temperature, before then comparing the adjusted pressure with the manufacturer's recommended pressure cold inflation pressure to determine that the recommended tire pressure has been obtained; and
generating a signal cognizable by the operator outside the vehicle so that the operator will cease filling the tire when the pressure is obtained.

10. The method of claim 9 further comprising establishing the calibration temperature at the temperature of the air in the tire at vehicle power-up following the vehicle being stationary for a predetermined period of time.

11. The method of claim 9 further comprising adjusting the measured pressure in the tire by the formula:
P_{adj}=[(273+Tₘ)/(273+T_{cal})]*P_{placard}
where Tₘ is the air temperature measured in the tire, T_{cal} is the established calibration temperature and P_{placard} is the cold inflation temperature recommended for the vehicle.

12. The method of claim 9 further comprising generating a signal cognizable by the operator by flashing the vehicle exterior lights.

13. The method of claim 9 further comprising generating a signal cognizable by the operator by sounding the vehicle horn.

14. A method for monitoring the fill-up of a vehicle tire to the cold inflation pressure recommended for a cold tire condition, comprising:
collecting temperature and pressure data from the tire;
establishing a calibration temperature that corresponds to temperature of air in the tire at vehicle power-up during the most recent 3 hour period of stationary non-movement of the vehicle;
determining that the vehicle tire is being filled with air by detecting that the vehicle is stationary while observing that the rate of pressure increase exceeds that rate of pressure increase that could occur by heating of the tire;
if the temperature of air in the tire is equal to or less than the calibration temperature, then comparing the adjusted pressure with the manufacturer's recommended pressure cold inflation pressure to determine that the recommended cold inflation tire pressure has been obtained;
if the temperature of air in the tire exceeds the calibration temperature, then adjusting the measured tire pressure to compensate for the difference between the measured temperature and the calibration temperature corresponding to a cold inflation temperature and comparing the adjusted pressure with the manufacturer's recommended pressure cold inflation pressure to determine that the recommended cold inflation tire pressure has been obtained; and
generating an audible or visual signal cognizable by the operator outside the vehicle.

15. The method of claim 14 further comprising adjusting the measured pressure in the tire by the formula
P_{adj}=[(273+Tₘ)/(273+T_{cal})]*P_{placard}
where Tₘ is the air temperature measured in the tire, T_{cal} is the established calibration temperature and P_{placard} is the cold inflation temperature recommended for the vehicle.

16. The method of claim 14 further comprising generating a signal cognizable by the operator by flashing the vehicle exterior lights.

17. The method of claim 14 further comprising generating a signal cognizable by the operator by sounding the vehicle horn.
